(19) United States
(12) Patent Application Publication
(10) Pub. No.: US 2006/0202090 A1
(43) Pub. Date: Sep. 14, 2006

(54) Display apparatus

(76) Inventors: Kyung-Kyun Lee, Seoul (KR); Gi-chun Lee, Yongin-si (KR)

Correspondence Address: STANZIONE & KIM, LLP, 919 18TH STREET, N.W., SUITE 440, WASHINGTON, DC, 20006, US

(21) Appl. No.: 11/320,798

(22) Filed: Dec. 30, 2005

(30) Foreign Application Priority Data
Mar. 8, 2005 (KR) 2005-18982

(51) Int. Cl. F16L 3/00

(52) U.S. Cl. 248/121

(57) ABSTRACT

A display apparatus includes a first body having a bracket formed with a horizontal surface region and a vertical surface region extended from a side of the horizontal surface region in a substantially perpendicular direction, and a second body having a supporting stand that includes a vertical stopper to support the vertical surface region and a horizontal stopper to support the horizontal surface region.

### CROSS-REFERENCE TO RELATED APPLICATION

This application claims priority to and the benefit of Korean Patent Application No. 10-2005-0018982, filed on Mar. 8, 2005, which is hereby incorporated by reference for all purposes as if fully set forth herein.

### BACKGROUND OF THE INVENTION

1. Field of the Invention

The invention relates to a display apparatus, and more particularly, to a display apparatus having an improved supporting structure.

2. Description of the Related Art

A conventional display apparatus is typically installed in a stand-up style in order to stand on the ground or a bottom surface. A thin display apparatus, such as an LCD (liquid crystal display), a PDP (plasma display panel), etc., uses a wall-mounted type display apparatus. Accordingly, a structure is needed to easily attach and detach a display main body and a supporting stand combined with a lower part of the display main body.

FIG. 1 is an enlarged perspective view showing a detachable structure located between a display main body 20 and a stand 30 that is included in a conventional display apparatus 10. As shown in FIG. 1, a cover bracket 21 is installed in the lower center of the display main body 20 to fasten or secure the stand 30. A supporting stand 31 is provided in an upper part of the stand 30 and is inserted into the cover bracket 21. According to the abovementioned formation, when the stand 30 is used for a stand-up style display apparatus 10, the supporting stand 31 of the stand 30 is inserted into the cover bracket 21, thereby supporting the display main body 20 on the ground. When the stand 30 is used for a wall-mounted display apparatus 10, the supporting stand 31 of the stand 30 may be easily detached or displaced from the cover bracket 21.

According to the conventional support technology as discussed above, the display main body 20 requires an additional cover bracket 21, which necessitates more space between the display main body 20 and the wall surface. Specially, in case of the wall-mounted display apparatus, unnecessary space is formed between the display apparatus and a surface of a wall due to the cover bracket 21. It is needed to reduce such space and to improve a structure of the cover bracket 21, which will reduce a manufacturing cost of the display apparatus.

### SUMMARY OF THE INVENTION

The invention provides a display apparatus having a stand easily detached, a display main body that does not include excess space, and a simplified detachable structure as compared with a conventional display apparatus, thereby decreasing a manufacturing cost of the display apparatus.

Additional features of the invention will be set forth in the description which follows, and in part will be apparent from the description, or may be learned by practice of the invention.

The invention discloses a display apparatus including a first body having a bracket having a horizontal surface region and a vertical surface region extending from a side of the horizontal surface region in a substantially perpendicular direction; and a second body having a supporting stand having a vertical stopper supporting the vertical surface region of the bracket and a horizontal stopper supporting the horizontal surface region.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a partial perspective view of a conventional display apparatus.

FIG. 2 is a partial perspective view of a display apparatus according to an embodiment of the invention.

FIG. 3 is a perspective view of a bracket included with the display apparatus shown in FIG. 2.

FIG. 4a and FIG. 4b are perspective views of a supporting stand included with the display apparatus shown in FIG. 2.

FIG. 5 is a lateral view showing a combined state of the bracket shown in FIG. 3 and the supporting stand shown in 4a.

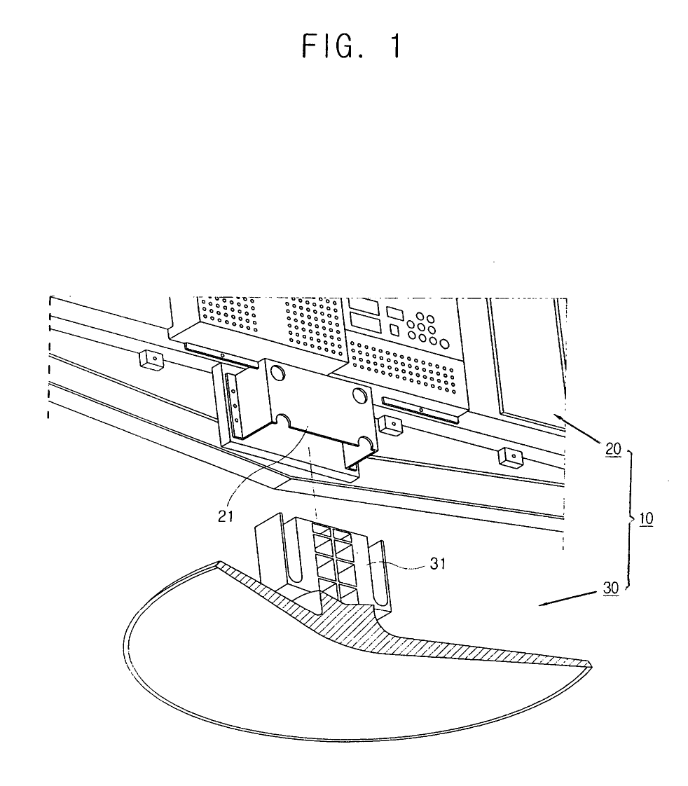

### DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity.

It is understood that when an element or layer is referred to as being “on” or “connected to” or “connected with” another element or layer, it can be directly on or directly connected to or with the other element or layer or intervening elements or layers may be present.

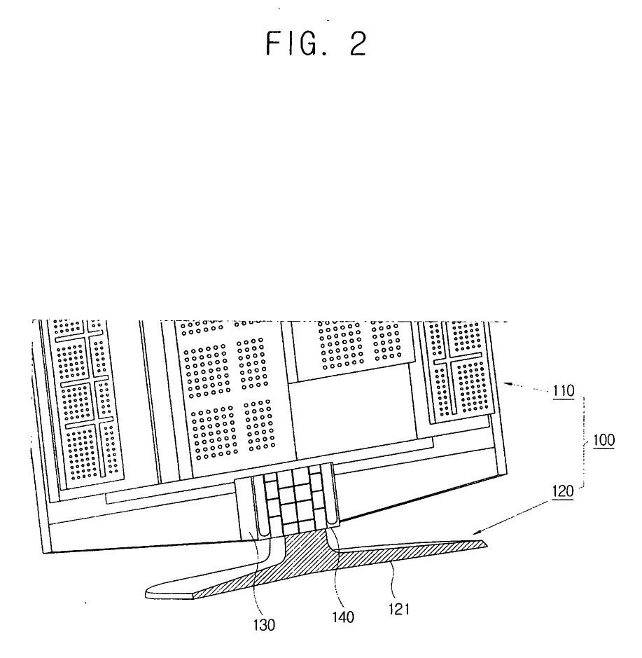

As shown in FIG. 2, according to an embodiment of the invention a display apparatus 100 includes a display main body 110 and a stand 120 supporting the display main body 110 on a surface, e.g., a ground surface. A bracket 130 is attached with a lower and substantially center part of the display main body 110.

The stand 120 includes a stand main body 121 and a supporting stand 140 that is attached with an upper end of the stand main body 121. The supporting stand 140 is detachably attached with the bracket 130 of the display main body 110.

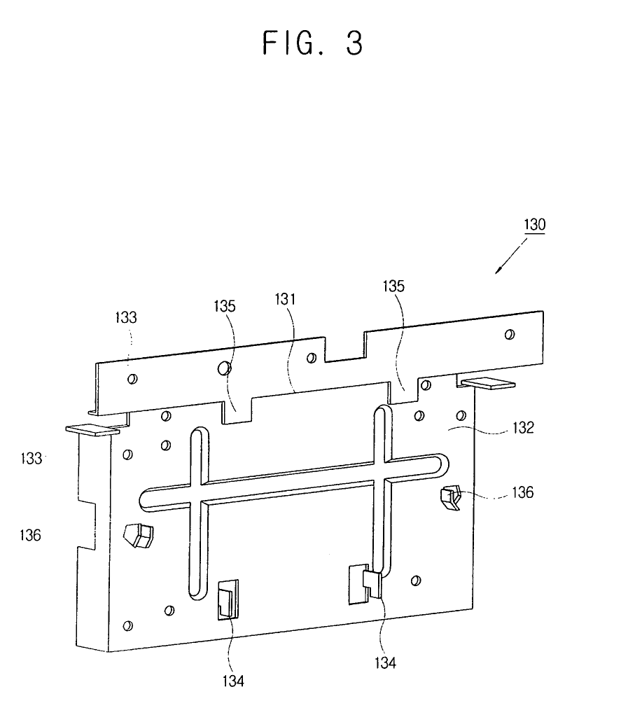

According to an embodiment of the bracket 130 shown in FIG. 3, the bracket 130 may include a horizontal surface part 131 and a vertical surface part 132 extended from one side of the horizontal surface part 131 downward in a substantially perpendicular direction. The bracket 130 may be attached with the display main body 110, shown in FIG. 2, through a plurality of fastening holes 133. The bracket 130 includes at least one vertical projection 134, e.g., preferably two, formed on a substantially inner lower part of the vertical surface part 132 and at least one horizontal projection 135, e.g., preferably two, formed on the horizontal surface part 131. Both ends of the vertical surface part 132 may include a guide projection 136, respectively to prevent or substantially prevent the supporting stand 140 from shifting moving from side to side when the supporting stand 140 slides down the vertical surface part 132.

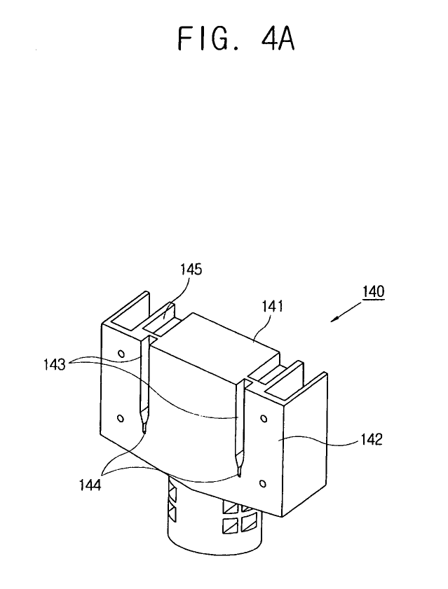

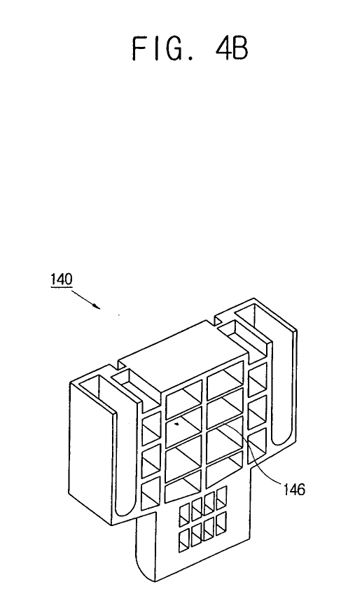

As shown in FIG. 4a, the supporting stand 140 comprises an upper surface region 141 supporting the horizontal surface part 131 of the bracket 130 upward in a substantially vertical direction and a side surface region 142 supporting the vertical surface part 132 of the bracket 130 in a substantially horizontal direction by making contacting with the bracket 130 shown in FIG. 3. The side surface region 142 includes at least one guide groove 143, e.g., preferably two grooves, where the vertical projection 143 of the bracket 130 is inserted and slides. The lower end of each guide groove 143 includes a guide end part 144 supporting the vertical projection 134 in the substantially horizontal direction and the substantially vertical direction. The guide end part 144 functions as a stopper and may have various forms, in addition to a groove form in the embodiment, such as a step or a through hole on the side surface part 142 or the like.

Meanwhile, the upper surface region 141 of the supporting stand 140 includes a horizontal stopper having at least one groove 145, e.g., preferably two grooves, where the horizontal projection 135 of the bracket 130 is inserted and supported in the substantially horizontal direction. Similar to the vertical stopper, the horizontal stopper may also have various forms in addition to the groove, such as a step, a through hole or the like.

As shown in FIG. 4, when the groove 145 supports the horizontal projection 135 of the bracket 130 in one substantially horizontal direction, the side surface part 142 supports the vertical surface part 132 of the bracket 130 in the other substantially horizontal direction. Accordingly, the groove 145 and the side surface part 142 always support the bracket 130 in opposite horizontal directions to each other.

As shown in the embodiment shown in FIG. 4b, the supporting stand 140 includes a reinforcing material 146, which minimizes weight while maintaining a predetermined intensity.

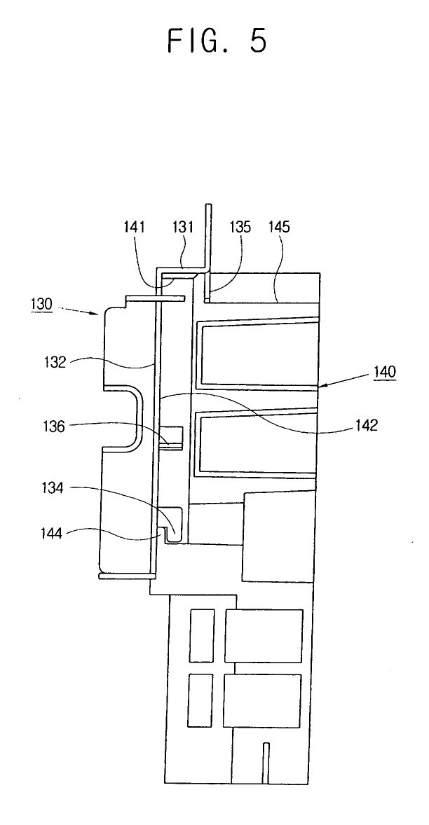

The bracket 130 and the supporting stand 140 having at least the above described structure are combined as shown in the embodiment shown in FIG. 5. For example, as shown, the vertical projection 134 arranged on the vertical surface region 132 of the bracket 130 is inserted into the guide end part 144 arranged at the substantially lower end of the guide groove 143 shown in FIG. 4a of the supporting stand 140, thereby being supported. The horizontal projection 135 on the horizontal surface region 131 of the bracket 130 is inserted into the groove 145 of the upper surface region 141 of the supporting stand 140, thereby being supported. Meanwhile, the vertical surface region 132 of the bracket 130 is supported by making contact with the side surface part 142 of the supporting stand 140 in the substantially horizontal direction.

Accordingly, a force being applied in a substantially downward perpendicular direction that is transferred from the bracket 130 is substantially supported by the upper surface region 141 of the supporting stand 140 and a force that being applied in a substantially horizontal direction that is transferred from the bracket 130 is substantially supported by the groove 145 of the supporting stand 140, the side surface part 142 and the guide end part 144.

It will be apparent to those skilled in the art that various modifications and variation can be made in the invention without departing from the spirit or scope of the invention. Thus, it is intended that the invention cover the modifications and variations of this invention provided they come within the scope of the appended claims and their equivalents.

What is claimed is:

1. A display apparatus, comprising:
a first body comprising a bracket having a horizontal surface part and a vertical surface part extending from a side of the horizontal surface part in a substantially perpendicular direction; and
a second body comprising a supporting stand having a vertical stopper supporting the vertical surface part of the bracket and a horizontal stopper supporting the horizontal surface part.

2. The display apparatus of claim 1, wherein the bracket further comprises a horizontal projection arranged on the horizontal surface part and supported by the horizontal stopper and a vertical projection arranged on the vertical surface part and supported by the vertical stopper.

3. The display apparatus of claim 2, wherein the supporting stand further comprises a guide groove enabling the vertical projection to slide in a substantially vertical direction, the vertical stopper comprises a guide end part arranged at a lower end portion of the guide groove to support the vertical projection, and the horizontal stopper comprises a groove arranged at an upper side region of the supporting stand.

4. The display apparatus of claim 3, wherein the supporting stand further comprises a side surface part that contacts the bracket to support the bracket in the substantially horizontal direction.

5. The display apparatus of claim 4, wherein the vertical surface part of the bracket further comprises a guide projection that guides the supporting stand during sliding.

6. The display apparatus of claim 2, wherein the supporting stand further comprises a side surface part that contacts the bracket to support the bracket in the substantially horizontal direction.

7. The display apparatus of 6, wherein the vertical surface part of the bracket further comprises a guide projection that guides the supporting stand during sliding.

8. The display apparatus of claim 1, wherein the supporting stand further comprises a side surface part that contacts the bracket to support the bracket in the substantially horizontal direction.

9. The display apparatus of claim 8, wherein the vertical surface part of the bracket further comprises a guide projection that guides the supporting stand during sliding.

10. The display apparatus of claim 1, wherein the first body is a main display body and the second body is a stand for the main display body.
